(19) United States
(12) Patent Application Publication
(10) Pub. No.: US 2017/0113280 A1
(43) Pub. Date: Apr. 27, 2017

(54) CONSTRUCTION TOOL APPARATUS

(71) Applicant: John P Marra, Jr., Mount Bethel, PA (US)

(72) Inventor: John P Marra, Jr., Mount Bethel, PA (US)

(21) Appl. No.: 15/315,263

(22) PCT Filed: May 29, 2015
(86) PCT No.: PCT/US2015/033244

§ 371 Date: Nov. 30, 2016

Related U.S. Application Data
(60) Provisional application No. 62/005,398, filed on May 30, 2014.

(51) Int. Cl. B23B 47/28; E04G 21/16

(52) U.S. Cl. CPC B23B 47/28; E04G 21/16; B23B 2247/10; B23B 2247/12; E04B 2/70

(57) ABSTRACT

An construction tool apparatus for facilitating the task of joining framing together includes a includes a template having a peripheral wall arranged about a longitudinal plane and with an internal chamber for reception of a section of a construction framing member of predetermined shape, a first guide defining a first guide throughbore extending along a first axis which is arranged at a first oblique angle with respect to the longitudinal plane and a second guide defining a second guide throughbore extending along a second axis which is arranged at a second oblique angle with respect to the longitudinal plane. The first and second throughbores are adapted for reception of a drill to form first and second pilot holes in the section of the framing member. The first and second oblique angles each range from about 50° to 58° degrees relative to the longitudinal plane. In one embodiment, the first and second oblique angles are substantially equivalent.

### BACKGROUND

1. Technical Field

The present disclosure is directed to a construction tool apparatus, and, in particular, relates to a carpenter's tool to facilitate securement of framing at angles, for example, in connection with toe-nailing of framing material.

2. Description of Related Art

The joining of framing or studs to each other, e.g., in a toe nail relation, may be very challenging even for experienced carpenters. Generally, the fasteners must be driven through the framing at a desired angle to catch both the vertical and the underlying base plates to adequately secure the framing material. Limited access to the framing material during construction, inexperience of the practicing carpenter etc., presents issues, which may be deleterious to effectively accomplishing this carpentry technique.

### SUMMARY

Accordingly, the present disclosure is directed to an apparatus and method which facilitates the task of joining framing together particularly in toe nail arrangement. In one embodiment, a construction tool apparatus includes a template having a peripheral wall arranged about a longitudinal plane and with an internal chamber for reception of a section of a construction framing member of predetermined shape, a first guide defining a first guide throughbore extending along a first axis which is arranged at a first oblique angle with respect to the longitudinal plane and a second guide defining a second guide throughbore extending along a second axis which is arranged at a second oblique angle with respect to the longitudinal plane. The first and second throughbores are adapted for reception of a drill to form first and second pilot holes in the section of the framing member. The first and second oblique angles each range from about 50° to 58° relative to the longitudinal plane. In one embodiment, the first and second oblique angles are substantially equivalent.

The peripheral wall of the template may define a general rectangular configuration having first and second side wall segments and first and second end wall segments. The first and second guides may be disposed along the first side wall segment of the peripheral wall of the template. The first guide may be positioned a first predetermined distance from the first end wall segment of the peripheral wall and the second guide is positioned a second distance from the second end wall segment where the first and second distances are different.

The internal chamber of the peripheral wall may be dimensioned to receive one of a 2″×3″, 2″×4″, 2″×6″, 2″×8″, 2″×10″ or 2″×12″ framing member.

In embodiments, a third guide defines a third guide throughbore extending along a third axis which is arranged at a third oblique angle with respect to the longitudinal plane. The third guide is disposed along the second side wall segment of the peripheral wall of the template.

In embodiments, a third guide may be disposed along the second side wall segment of the peripheral wall of the template and defines a third guide throughbore extending along a third axis arranged at a third oblique angle with respect to the longitudinal plane. The third guide may be positioned a third predetermined distance from the first end wall segment of the peripheral wall. The first and third predetermined distances of the respective first and third guides may be different. A fourth guide may be disposed along the second side wall segment of the peripheral wall of the template and defines a fourth guide throughbore extending along a fourth axis which is arranged at a fourth oblique angle with respect to the longitudinal plane. The fourth guide may be positioned a fourth predetermined distance from the second end wall segment of the peripheral wall. The second and fourth predetermined distances of the respective second and fourth guides may be different.

In embodiments, at least one of the first and second guides may be separable from the peripheral wall.

In another embodiment, a method of joining first and second construction framing members, includes:

introducing an end segment of a first framing member of a predetermined shape into an internal chamber of a template;

advancing a drill within first and second guide throughbores of the template to establish first and second pilot holes in the end segment of the first framing member, the first and second guide throughbores arranged at first and second oblique angles relative to a longitudinal plane of the template;

positioning the end segment of the first framing member in toe relation to a second frame member; and

delivering first and second fasteners through the first and second pilot holes and into the second framing member to secure the first framing member to the second framing member.

In one embodiment, advancing the drill includes establishing the first and second pilot holes through a first side of the framing member, and thereafter maneuvering one of the first framing member and the template to position the first and second guide throughbores adjacent a second side of the framing member opposing the first side. The method may further include advancing the drill through the first and second guide throughbores to establish third and fourth pilot holes through the second side and within the end segment of the first framing member. Third and fourth fasteners may be delivered through the third and fourth pilot holes and into the second framing member to secure the first framing member to the second framing member.

The apparatus and method of the present disclosure facilitates the task of joining construction framing together, e.g., through toenailing, by creating a reliable and efficient methodology ensuring the fasteners catch sufficient volume of construction material or wood of the joined framing to secure the framing in a lasting manner. Other advantages of the present disclosure will become apparent from the following description.

### BRIEF DESCRIPTION OF THE DRAWINGS

Embodiments of the present disclosure will be appreciated by reference to the accompanying drawings wherein:

FIGS. 1-2 are perspective views of the construction tool apparatus in accordance with the principles of the present disclosure;

FIGS. 3-4 are first and second side elevation views of the construction tool apparatus;

FIG. 5 is a top plan view of the construction tool apparatus;

FIG. 6 is a flow chart illustrating a method of use of the construction tool apparatus for joining first and second framing members in toe nail relation;

FIG. 7 is a view illustrating use of the construction tool apparatus to drill pilot holes in a first framing member;

FIGS. 8 is a view illustrating fasteners introduced through each side of the first framing member and into the second horizontal framing member to secure the framing members to each other in toe nail relation; and

FIG. 9 is a top plan view of another alternate embodiment of the construction tool apparatus.

### DETAILED DESCRIPTION

Particular embodiments of the present disclosure are described hereinbelow with reference to the accompanying drawings; however, it is to be understood that the disclosed embodiments are merely examples of the disclosure and may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to employ the present disclosure in virtually any appropriately detailed structure.

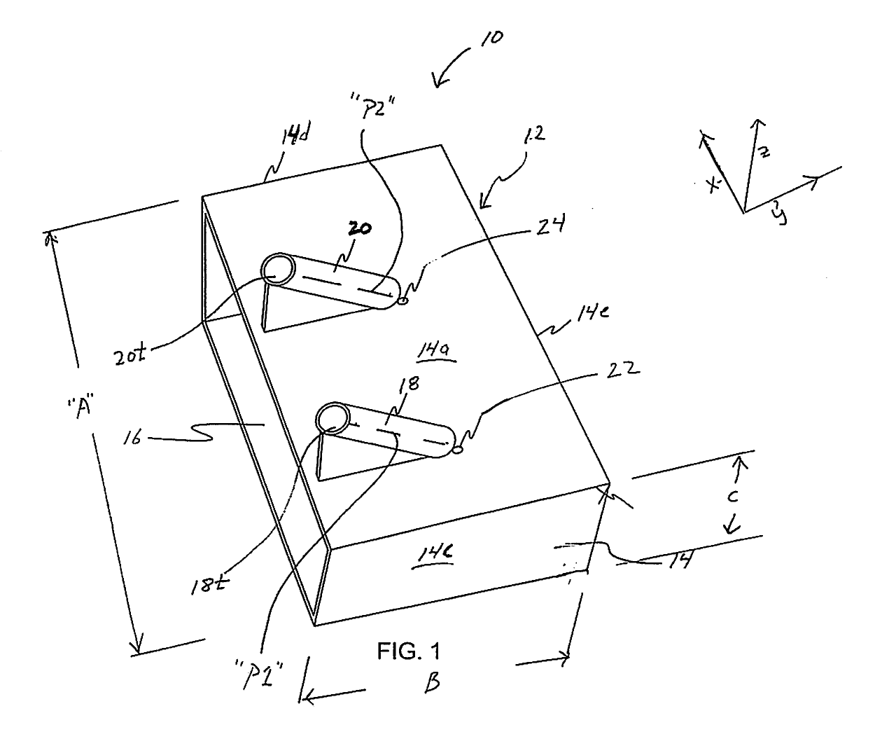

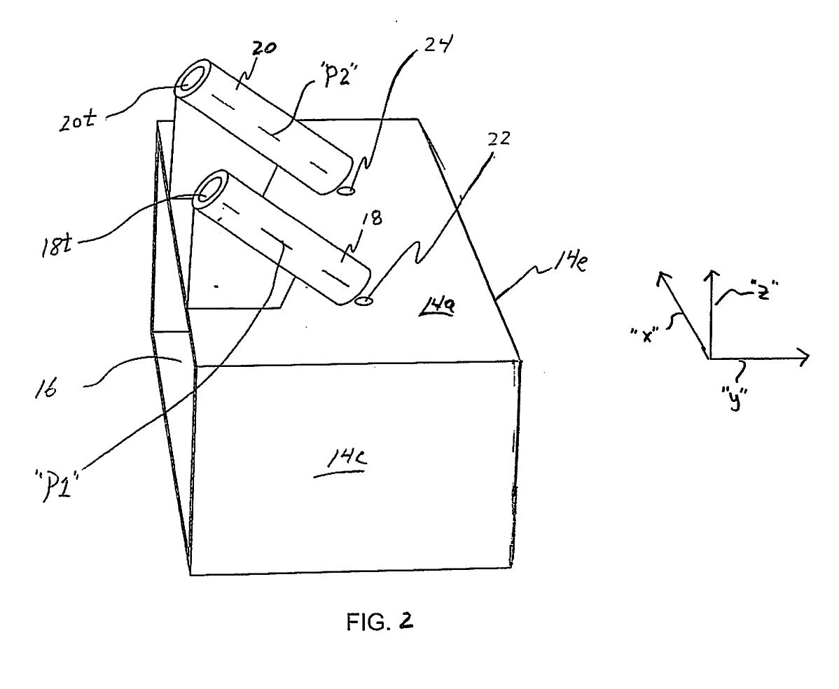

Referring now to the drawings where like reference numerals indicate similar components throughout the several views, FIGS. 1-5 illustrate the construction tool apparatus 10 in accordance with the principles of the present disclosure. The construction tool apparatus 10 includes a template 12 having an outer peripheral wall 14 defining an internal chamber 16 for at least partial reception of an end segment of framing. In one embodiment, the peripheral wall defines an “x” axis, a “y” axis and a “z” axis. The peripheral wall 14 may define a rectangular configuration having opposed first and second side wall segments 14a, 14b, opposed first and second end wall segments 14c, 14d and bottom wall segment 14e. The dimensioning of the template 12 may be suitable for a 2″×3″, 2″×4″, 2″×6″, 2″×8″, 2″×10″, 2″×12″, and/or 2″×14″ framing material or studs. In the embodiment depicted, the template 12 is adapted for use with 2″×4″ framing. For example, the template 12 defines a length “A” along the x-axis (internal dimension) of about 3½ A inches, a width or depth “B” (internal dimension) along the y-axis of about 2¼ inches and a height “C” along the z-axis of about 1½ inches. Other dimensions are contemplated, e.g., for use with any of the sized framing studs identified hereinabove.

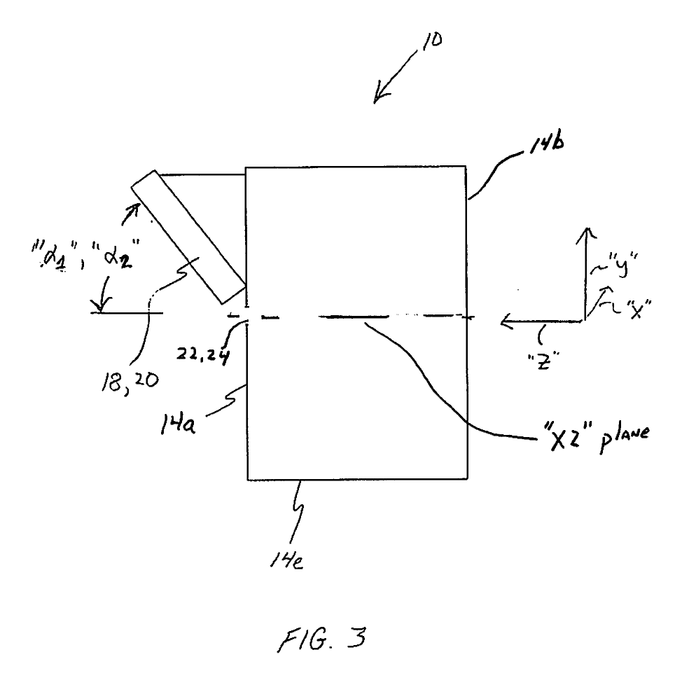

The template 12 further includes first and second guides or guide tubes 18, 20 positioned or mounted to the first side wall segment 14a of the peripheral wall 14 of the template 12. The first and second guide tubes 18, 20 may be partial or full cylinders, tubes or any other arrangement suitable to guide a drill bit. The first and second guide tubes 18, 20 define respective first and second guide throughbores 18t, 20t extending along respective first and second axes “p1”, “p2”. The first and second guide throughbores 18t, 20t are dimensioned for reception of a drill to form first and second pilot holes in the framing member. In embodiments, the first axis “p1” is arranged at a first oblique angle “α1” with respect to the longitudinal plane “xz” (or, e.g., relative to the bottom wall segment 14e) and the second axis “p2” is arranged at a second oblique angles “α2” with respect to the longitudinal “xz” plane of the template 12. The longitudinal plane “xz” is parallel to the bottom wall segment 14e. In FIG. 3, both “α1, α2” are represented as well as guide tubes 18, 20. In embodiments, the angles “α1, “α2” may range between about 48° to about 62° in a 2″×4″ application, or range between about 50° to 58°, preferably between about 54°-56°, or more preferably 54°. In embodiments, the angles “α1”, “α2” are the same. In other embodiments, the angles “α1, “α2” may be different. Other arrangements are also envisioned.

The guide tubes 18, 20 are aligned with respective openings 22, 24 through the first side wall segment 14a of the template 12. The openings 22, 24 may be positioned about the midpoint of the first side wall segment 14a, e.g., about 1⅛ inches from the bottom wall segment 14e. Other dimensions are envisioned. The guide tubes 18, 20 are dimensioned to receive the drill bit of a drill to create pilot holes in the framing “f1” or wood positioned within the template 12 for securement with an adjoining piece of framing “f2”. The adjoining framing “f2” is typically at a right angle to the framing “f1” in which the template 12 is positioned to create a toenail joint between the respective framing pieces.

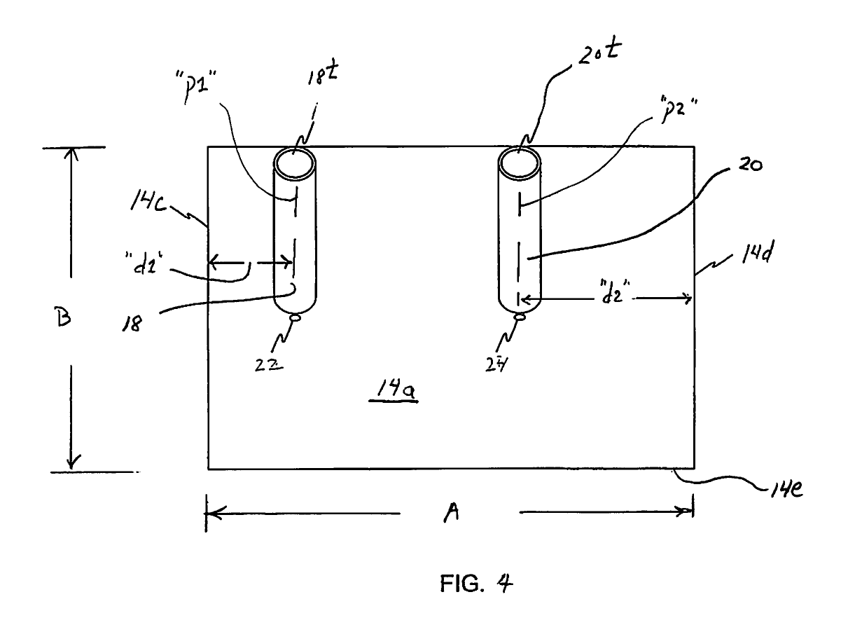

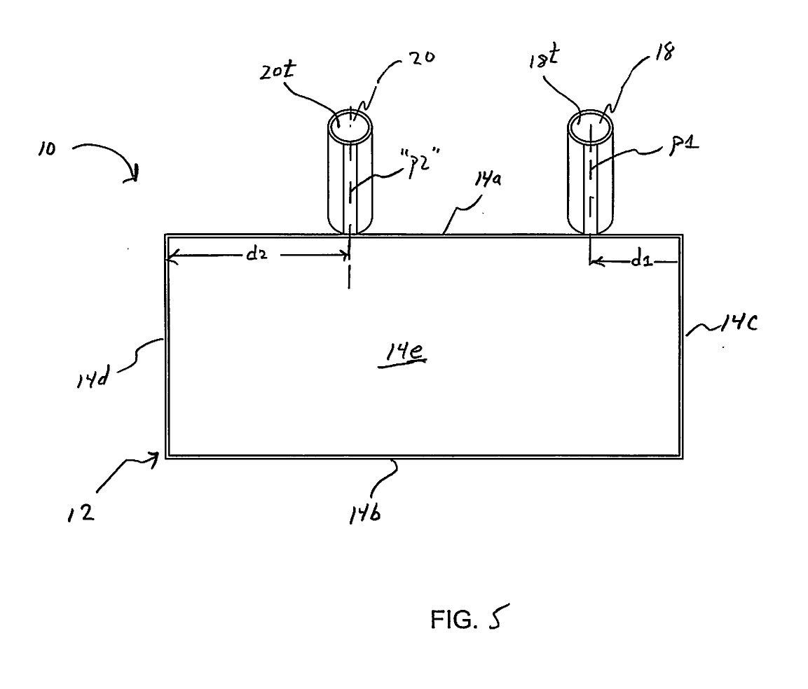

In accordance with one feature of the disclosure best depicted in FIGS. 4-5, the guide tubes 18, 20 may not be equally spaced relative to the respective adjacent first and second end wall segments 14c, 14d of the template 12, but, rather their respective axes “p1”, “p2” are at different predetermined distances “d1”, “d2” relative to the first and second end wall segments 14c, 14d. Although not restricted to particular dimensions identified herein, in one embodiment, “d1” is about 5/8 inches and “d2” is about 1¼ inches. The centers of the guide tubes 18, 20 between axes “p1”,“p2” may be spaced about 1⅝ inches. Other arrangements are also envisioned. The purpose of this offset relationship relative to the end wall segments 14c, 14d is to ensure that when the template 12 is rotated 180° to drill pilot holes in the second side of the framing, the opposing pilot holes will not intersect, i.e., they will be offset.

The selected angle “α1, “α2” of the guide tubes 18, 20 and the location of the guide tubes 18, 20 and openings 22, 24 will ensure that the fasteners catch a sufficient volume of framing material to secure the framing members in a lasting arrangement. In embodiments, at least 1 inch of wood is caught by the fasteners through the aforedescribed arrangement.

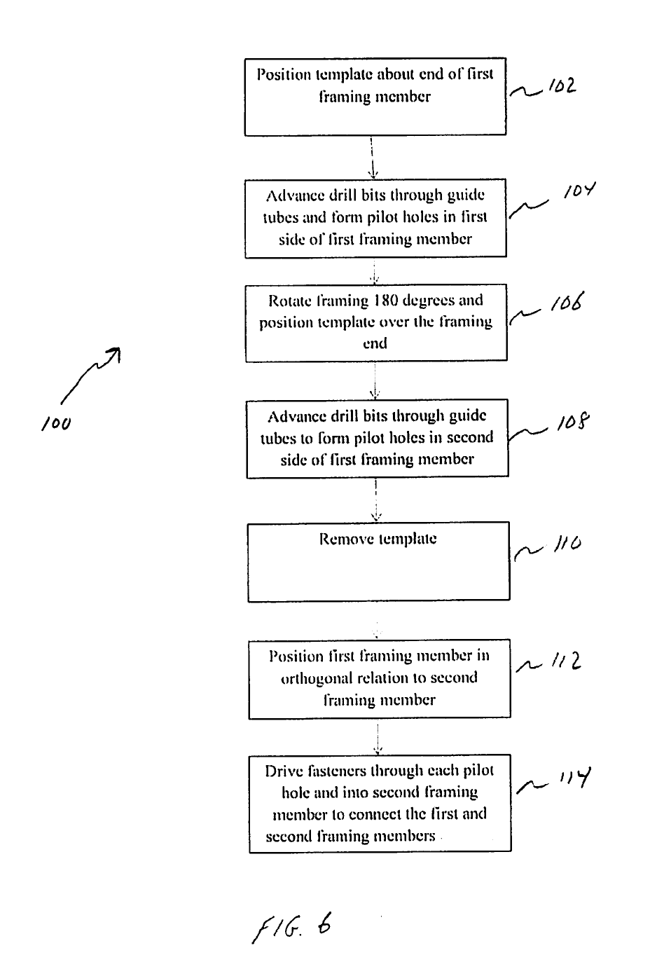

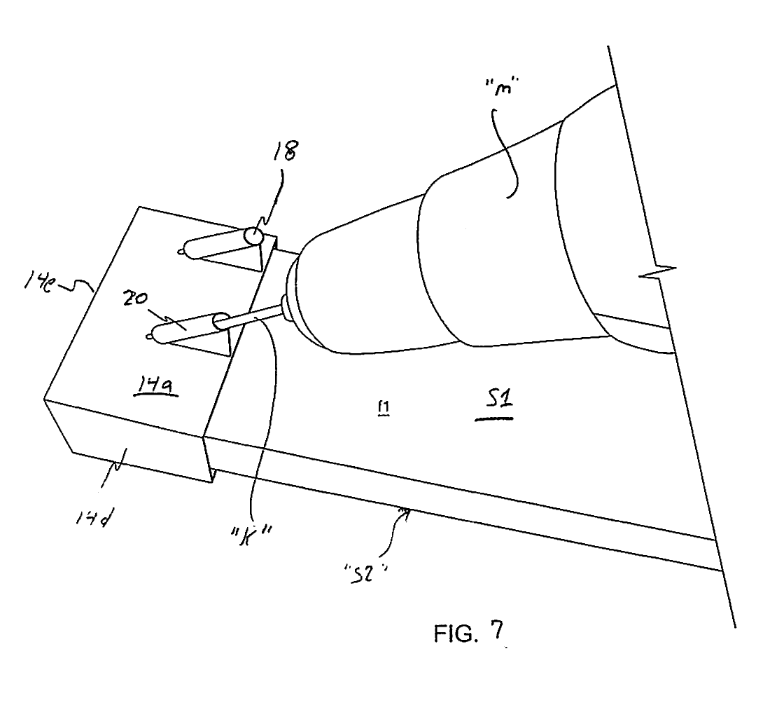

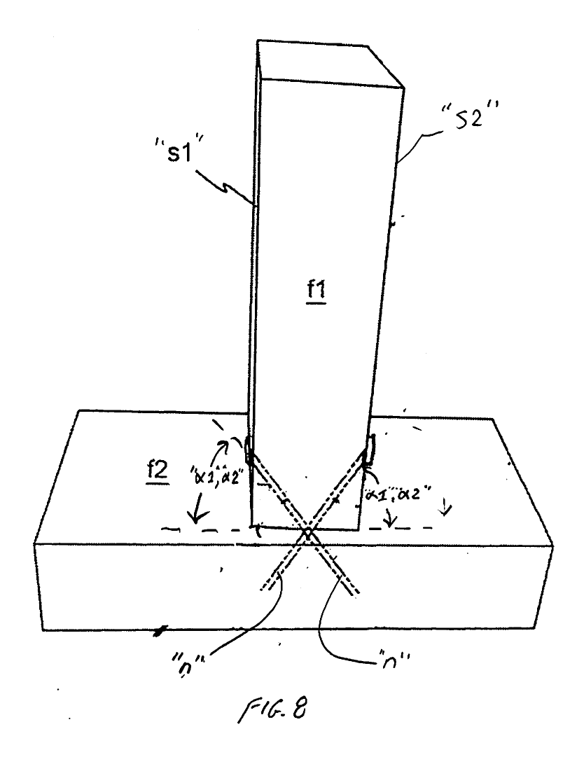

Referring now to the flow chart 100 of FIG. 6, the use of the construction tool apparatus 10 for joining first and second framing members in toe nail relation will be described. In use, the template 12 is positioned about the end of the framing “f1”, for example, a 2″×4″ (Step 102) and also depicted in FIG. 7 such that the bottom wall segment 14e engages the end of the framing member “f1”. A drill bit “k” of a drill “m” is positioned within each guide tube 18, 20 to drill pilot holes within the first side “s1” of the framing member “f1” (Step 104). The pilot holes will extend to the end face of the framing member “f1”, and are arranged at the oblique angles “α1”, “α2” defined by the guide tubes 18, 20. Thereafter, the framing member “f1” is rotated 180° , and the template 12 is positioned over the same end face of the framing member “f1”. (Step 106) The pilot holes are drilled in the same manner through the second side “s2” of the framing “f1”. (Step 108) Due to the offset arrangement of the guide tube 18, 20 the pilot holes created through both sides “s1”, “s2” of the framing “f1” will not interfere or intersect with each other. With the pilot holes drilled, the template is removed (Step 110) and the framing member “f1” is positioned in orthogonal relation (e.g., toenail style) with respect to a second framing piece (Step 112) as depicted in FIG. 8. A fastener “n” (e.g., a nail or screw fastener or any other fattener type suitable to join framing together) is positioned within each pilot hole and then driven within the second framing piece “f2” to secure the first and second framing members “f1”, “f2” to each other in toe nail relation (Step 114). FIG. 8 depicts the fasteners “n” in phantom extending through the first framing member “f1” depicting the angles at which the pilot holes are formed corresponding to the angles “α1”, “α2” (shown for illustrative purposes) defined by the guide tubes 18, 20. The fasteners “n” are driven to penetrate the second framing member “f2”. As shown, the selected angles “α1”, “α2” will position the fasteners “n” approximately through the center of the framing “f1” thereby ensuring a sufficient volume of wood or composite material is caught by the fasteners “n” to establish an effective positive securement of the two pieces of framing “f1”, “f2”.

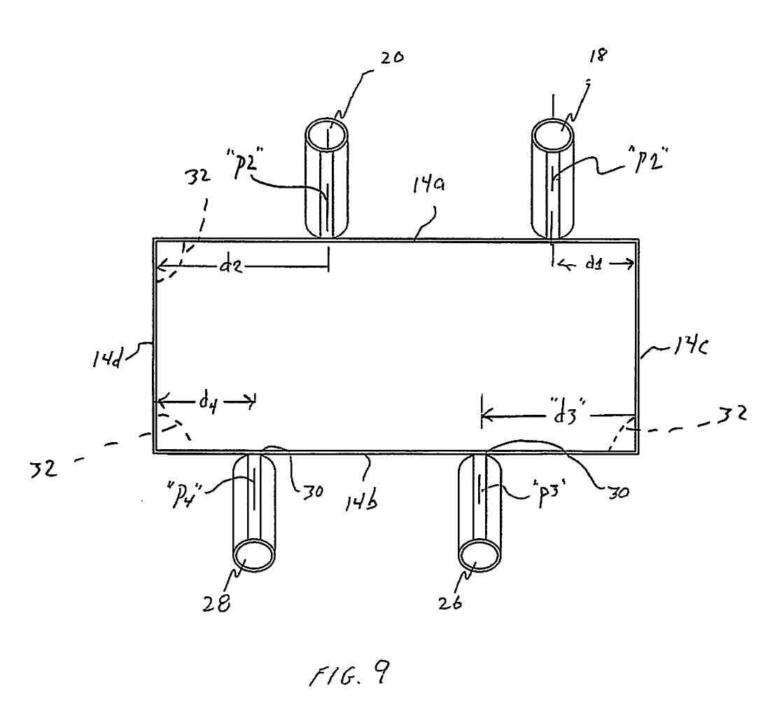

In an alternate embodiment depicted in FIG. 9, the template 12 may include a second set of guide tubes 26, 28 on the opposed second side wall segment 14b of the template 12 and arranged in offset relationship with each other and with the guide tubes 18, 20 on the opposed side wall of the template 12. For example, the axes “p3”, “p4”of the guide tubes 26, 28 may be at different predetermined distances “d3”, “d4” relative to the respective first and second end wall segments 14c, 14d. Distances “d1” and “d3” would be different and distances “d2” and “d4” would be different. With this arrangement, all of the pilot holes may be drilled without switching or rotating the template 12 about the end of the first framing piece “f1”, and the pilot holes will each be offset with respect to each other. As a further feature, any or all the guide tubes 18, 20, 26, 28 may be separable from the peripheral wall, e.g., separated along connection segments 30 as depicted with the guide tubes 26, 28. With this arrangement, the first framing member “f1” may be arranged in toe nail relation to the second frame member “f2” as depicted in FIG. 8 with the template 10 mounted over the end of the first framing member “f1”. The pilot holes may be drilled through the guide tubes 26, 28 and the guide tubes 26, 28 may be separated from the peripheral wall 14 of the template 10. Fasteners “n” may be advanced through the pilot holes. The same procedure may be followed to form pilot holes through the guide tubes 18, 20. Thus, in accordance with this embodiment, the template 10 may remain on the first framing member “f1” during the entire toe nailing process.

In another embodiment, the bottom wall segment 14e may be removed to reduce material cost. It is envisioned that one or small tabs 32 (shown in phantom in FIG. 9) may extend between adjacent sides, or a peripheral edge extend within the inner periphery, to prevent the template 12 from sliding down the framing “f1”. The tabs 32 may be dimensioned to engage the wood in the same manner as bottom wall segment 14e.

The framing material may be wood, wood composite, a polymer composite and/or combinations thereof.

While the above description contains many specifics, these specifics should not be construed as limitations on the scope of the present disclosure, but merely as exemplifications of embodiments thereof. It is envisioned that the elements and features illustrated or described in connection with one exemplary embodiment may be combined with the elements and features of another exemplary embodiment without departing from the scope of the present disclosure, and that such modifications and variations are also intended to be included within the scope of the present disclosure. Those skilled in the art will envision many other possible variations that are within the scope and spirit of the present disclosure.

What is claimed is:

1. A construction tool apparatus, which comprises:
a template including a peripheral wall arranged about a longitudinal plane and having an internal chamber for reception of a section of a construction framing member of predetermined shape;
a first guide defining a first guide throughbore extending along a first axis which is arranged at a first oblique angle with respect to the longitudinal plane, the first guide throughbore for reception of a drill to form a first pilot hole in the section of the framing member; and
a second guide defining a second guide throughbore extending along a second axis which is arranged at a second oblique angle with respect to the longitudinal plane, the second guide throughbore for reception of a drill to form a second pilot hole in the section of framing member.

2. The construction apparatus according to claim 1 wherein the first and second oblique angles each range from about 50° to 58° relative to the longitudinal plane.

3. The construction apparatus according to claim 2 the first and second oblique angles are substantially equivalent.

4. The construction apparatus according to claim 1 wherein the peripheral wall of the template defines a general rectangular configuration having first and second side wall segments and first and second end wall segments.

5. The construction apparatus according to claim 4 wherein the first and second guides are disposed along the first side wall segment of the peripheral wall of the template.

6. The construction apparatus according to claim 5 wherein the first guide is positioned a first predetermined distance from the first end wall segment of the peripheral wall and the second guide is positioned a second distance from the second end wall segment, the first and second distances being different.

7. The construction apparatus according to claim 6 wherein the internal chamber of the peripheral wall is dimensioned to receive one of a 2″×3″, 2″'4″, 2″×6″, 2″×8″, 2″×10″ or 2″×12″ framing member.

8. The construction apparatus according to claim 6 wherein including a third guide defining a third guide throughbore extending along a third axis which is arranged at a third oblique angle with respect to the longitudinal plane, the third guide disposed along the second side wall segment of the peripheral wall of the template.

9. The construction apparatus according to claim 6 wherein including a third guide defining a third guide throughbore extending along a third axis which is arranged at a third oblique angle with respect to the longitudinal plane, the third guide disposed along the second side wall segment of the peripheral wall of the template, the third guide being positioned a third predetermined distance from the first end wall segment of the peripheral wall, the first and third predetermined distances of the respective first and third guide being different.

10. The construction apparatus according to claim 9 including a fourth guide defining a fourth guide throughbore extending along a fourth axis which is arranged at a fourth oblique angle with respect to the longitudinal plane, the fourth guide disposed along the second side wall segment of the peripheral wall of the template, the fourth guide being positioned a fourth predetermined distance from the second end wall segment of the peripheral wall, the second and fourth predetermined distances of the respective second and fourth guide being different.

11. The construction apparatus according to claim 1 at least one of the first and second guides is separable from the peripheral wall.

12. A method of joining first and second construction framing members, comprising:
introducing an end segment of a first framing member of a predetermined shape into an internal chamber of a template;
advancing a drill within first and second guide throughbores of the template to establish first and second pilot holes in the end segment of the first framing member, the first and second guide throughbores arranged at first and second oblique angles relative to a longitudinal plane of the template;
positioning the end segment of the first framing member in toe relation to a second frame member; and
delivering first and second fasteners through the first and second pilot holes and into the second framing member to secure the first framing member to the second framing member.

13. The method according to claim 12 wherein advancing the drill includes establishing the first and second pilot holes through a first side of the framing member, and thereafter maneuvering one of the first framing member and the template to position the first and second guide throughbores adjacent a second side of the framing member opposing the first side.

14. The method according to claim 13 including advancing the drill through the first and second guide throughbores to establish third and fourth pilot holes through the second side and within the end segment of the first framing member and delivering third and fourth fasteners through the third and fourth pilot holes and into the second framing member to secure the first framing member to the second framing member.
